(19) United States
(12) Patent Application Publication
(10) Pub. No.: US 2007/0090041 A1
(43) Pub. Date: Apr. 26, 2007

(54) Self-cleaning intake screen

(76) Inventors: Russell M. Berry III, Elk Grove, CA (US); Russell M. Berry IV, Sacramento, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/586,270

(22) Filed: Oct. 24, 2006

Related U.S. Application Data
(60) Provisional application No. 60/730,511, filed on Oct. 25, 2005.

(51) Int. Cl. B01D 33/00

(52) U.S. Cl. 210/396; 210/402

(57) ABSTRACT

A self-cleaning screen that automatically cleans both the inside and outside surfaces of the cylindrical screen using only the rotation of the cylindrical screen itself. This self-cleaning ability is accomplished by using a fixed brush on the exterior surface of the screen, and a freely rotating brush on the interior surface of the screen, where the freely rotating brush is driven by the movement of the screen itself. A propeller driven by the flowing water being filtered can be used to rotate the screen.

This application claims the benefit of U.S. Provisional Application No. 60/730,511, filed Oct. 25, 2005, and entitled Self-Cleaning Intake Screen.

### FIELD OF THE INVENTION

This invention relates to intake screens to exclude material from entering a water inlet, and is particularly directed to an improved self-cleaning intake screen.

### BACKGROUND OF THE INVENTION

Self-cleaning intake screens are well known in the art. The earliest of such devices simply employed some mechanism to cause the screen, generally cylindrical in shape, to rotate within the stream or waterway. A water vacuum is generated inside the cylindrical screen, drawing water through the screen for filtration. As the screen rotates, any debris trapped on its upstream side would be washed away as it turns downstream. More sophisticated devices employ some sort of backwash system which, either continually or at periodic intervals, spray a high pressure jet of water or air against the screen in an attempt to blow debris off of and away from the outside of the screen. However, most self-cleaning intake screen designs are complicated and/or do not effectively keep the screen free from debris.

More recently, brushes and scrapers have been added to the outside of cylindrical screens, to scrape off debris and silt from the outer surface of the screen as the screen rotates, so that water flow through the screen to the interior of the screen is not unnecessarily impeded. However, for many applications, the interior of the screen still experiences an intolerable build up of debris and silt. For example, one application involves a screen made of wedge wires, which are thick wire strands that extend circumferentially around a support structure. The support structure includes longitudinally extending support members that are attached to the inside surface of the wedge wire screen, and are spaced one or several inches apart. It has been found that an external brush sweeping across the outer surface of the wedge wire screen fails to adequately clean the inside surface of the wedge wire and the support members, as well as possibly the laterally facing surfaces of the wedge wires. Spacing the support members further apart can reduce silt buildup, but then the screen no longer has the desired structural integrity, and the cylinder can lose its roundness as the wedge wire tends to lie flat between the support members.

It is also known to place a spirally oriented, motorized cleaning brush on the inside surface of a rotating cylindrically shaped screen, where the brush rotates in the opposite direction as the moving direction of the screen. However, such motorized cleaning brushes will not work with wedge wire type screens such as the one described above, because the brush will continually encounter the support members, which are not flush with the inside surface of the wedge wire screen. Thus, any brushes designed to clear the support members will not adequately clean the interior and lateral surfaces of the wedge wire. Moreover, it is expensive and difficult to include a separate motor, inside the cylindrical screen, to operate the rotating brush.

There is a need for an intake screen that reliably and effectively cleans itself, even its interior surfaces, without adding the complexity of additional motors.

### SUMMARY OF THE INVENTION

The present invention solves the aforementioned problems by providing a self-cleaning intake screen.

A self-cleaning intake screen comprises a rotatable intake screen configured to filter material from a flow of water, wherein the intake screen has openings for passing the flow of water. The screen further comprises a propeller coupled to the intake screen for rotating the intake screen as a flow of water passing the propeller drives the propeller. And finally, the screen comprises a first cleaning element operatively coupled to the intake screen so as to remove the material from the openings during rotation of the intake screen, wherein the first cleaning element is rotatably coupled to the intake screen so that rotation of the intake screen induces rotation of the first cleaning element against the intake screen, so as to remove the material from the openings when the intake screen is rotated, and wherein the openings are distributed across a cylindrical side portion of the intake screen, and wherein the first cleaning element extends longitudinally along an inner surface of the cylindrical side portion.

In another aspect of the present invention, a self-cleaning intake screen comprises a manifold, a cylindrically shaped screen defining a plurality of openings and rotatably mounted to the manifold, and a propeller disposed in the manifold and coupled to the intake screen for rotating the intake screen as a flow of water through the manifold drives the propeller. The screen further comprises a first cleaning element rotatably mounted to the manifold and engaged with the screen such that rotation of the screen causes rotation of the cleaning element, wherein the first cleaning element is a brush with bristles, and wherein the bristles penetrate into the screen openings as the brush rotates. Within this embodiment, the screen includes a plurality of spaced apart wires with the openings defined between the wires, and a plurality of support members extending along an interior surface of the screen, wherein the bristles engage with the interior surface of the screen.

In yet one more aspect of the present invention, a self-cleaning intake screen comprises a cylindrically shaped manifold, a cylindrically shaped screen disposed around the manifold in a rotatable manner relative to the manifold, wherein the screen comprises a plurality of openings, and a propeller disposed in the manifold and coupled to the intake screen for rotating the intake screen around the manifold as a flow of water through the manifold drives the propeller. The screen further comprises a first cleaning element rotatably mounted to the manifold and disposed between the manifold and the screen, wherein the cleaning element is engaged with an interior surface of the screen such that rotation of the screen causes rotation of the cleaning element.

Other aspects and advantages of the invention will become apparent from the following detailed description taken in conjunction with the accompanying drawings which illustrate, by way of example, the principles of the invention.

### BRIEF DESCRIPTION OF THE DRAWINGS

For a better understanding of the invention, reference should be made to the following detailed description taken in conjunction with the accompanying drawings, in which:

FIG. 1 is a cross-sectional side view of a self-cleaning intake screen.

FIG. 2 is a cross-sectional end view of the self-cleaning intake screen of the present invention.

FIG. 3 is a perspective view of the suction manifold of a self-cleaning intake screen.

FIGS. 4 and 5 are perspective views of the wedge wire surface and external brush of the self-cleaning intake screen of the present invention.

FIG. 6 is a perspective view of the interior of the self-cleaning intake screen of the present invention.

FIG. 7 is a top view of the internal brush of the self-cleaning intake screen of the present invention.

FIG. 8 is a perspective view of the suction manifold and internal brush of the self-cleaning intake screen of the present invention.

FIG. 9 is a perspective view of the wedge wire surface, external brush, and protruding bristles of the interior brush, of the self-cleaning intake screen of the present invention.

FIG. 10 is a cross-sectional side view of an alternate embodiment of a self-cleaning intake screen.

FIG. 11 is an end view of the alternate embodiment of a self-cleaning intake screen.

FIG. 12 is a partially broken away view of a self-cleaning intake screen according to another alternate embodiment.

FIG. 13 is an end view of a self-cleaning intake screen according to the alternate embodiment of FIG. 12.

Like reference numerals refer to corresponding parts throughout the drawings.

### DETAILED DESCRIPTION OF THE PREFERRED EMBODIMENTS

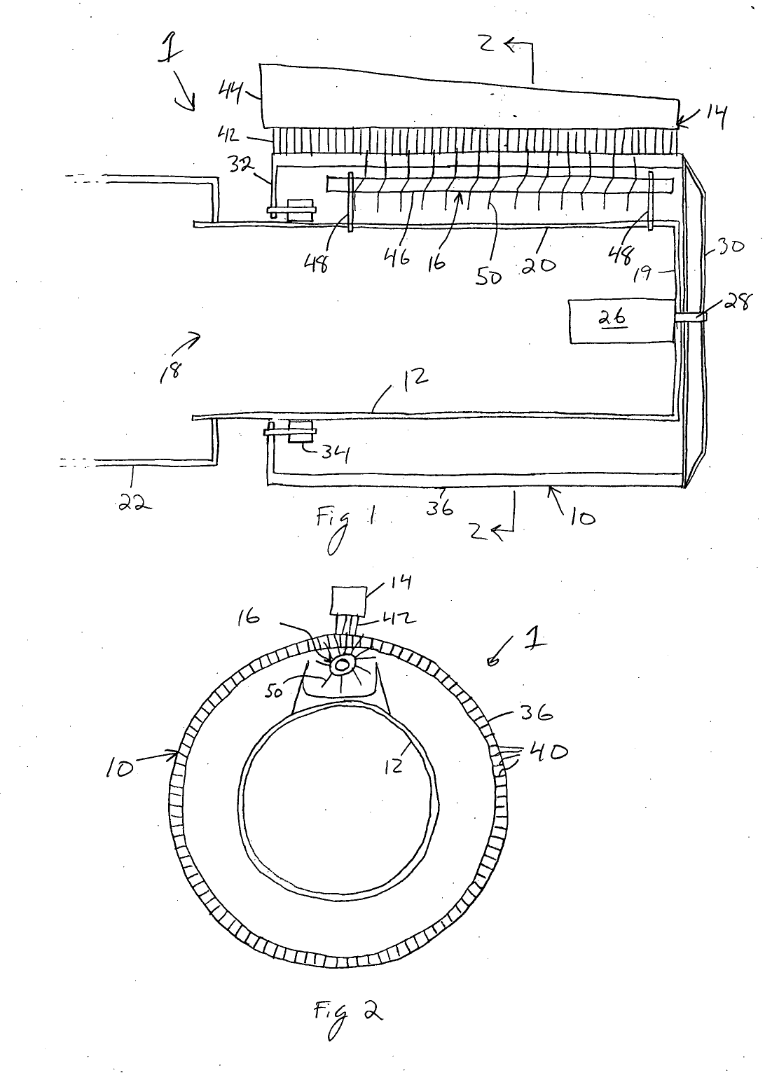

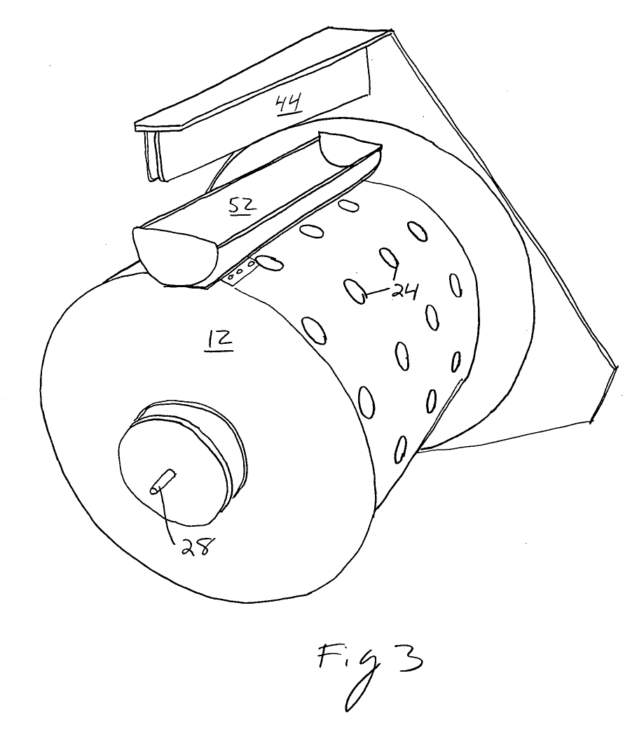

The present invention is a self-cleaning intake screen assembly 1, as shown in FIGS. 1 and 2. The assembly 1 includes a cylindrical shaped screen 10 rotatably mounted to a suction manifold 12, an external fixed brush 14, and an internal rotating brush 16. The entire assembly is designed to be submerged under water, where suction applied inside the suction manifold 12 draws water through the cylindrical screen 10 and the suction manifold 12, where the screen 10 filters out contaminants from the water.

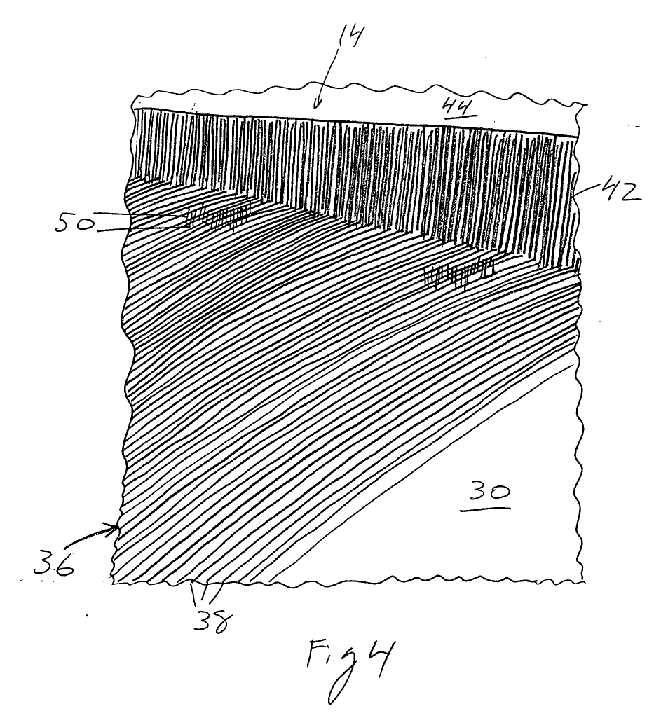

Suction manifold 12 is cylindrically shaped, having an open end 18, a closed end 19, and a cylindrically shaped sidewall 20. A pump manifold 22 (attached to the intake side of a pump which is not shown) is connected to the suction manifold 12, for drawing water through the screen 10 and the suction manifold 12 and eventually to the pump (not shown). The suction manifold 12 includes a plurality of apertures 24 formed in its cylindrical sidewall 20 through which water will flow, as better shown in FIG. 3. The apertures 24 are evenly spaced to ensure a more even flow of water though various portions of screen 10. Motor 26 is mounted to the closed end 20 of suction manifold 12, and includes a rotating drive shaft 28 that extends through the suction manifold closed end 20.

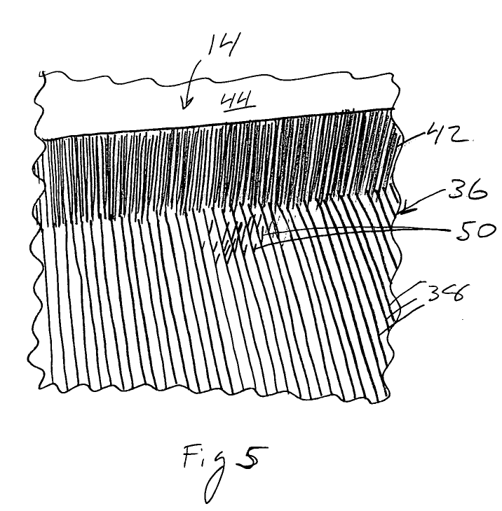

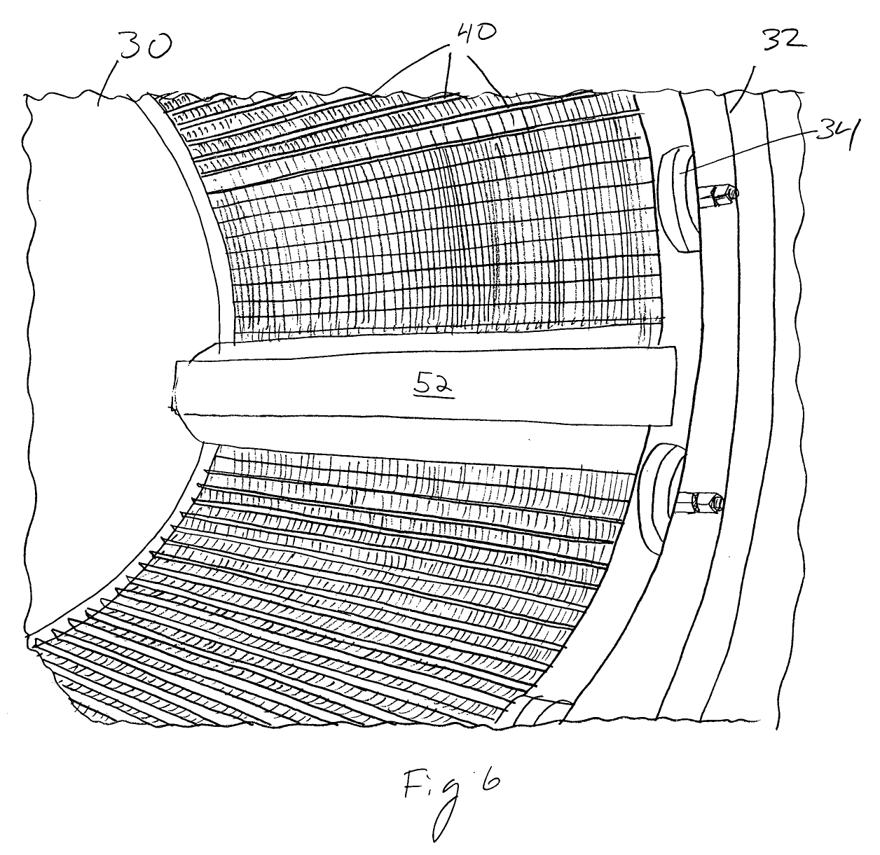

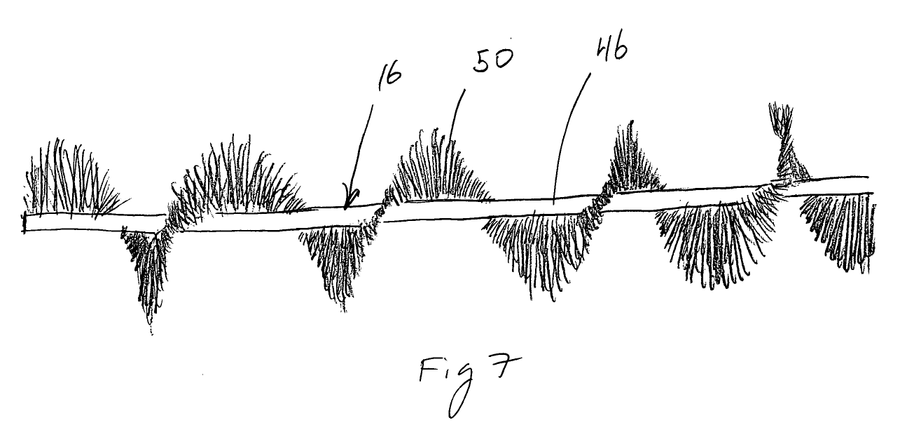

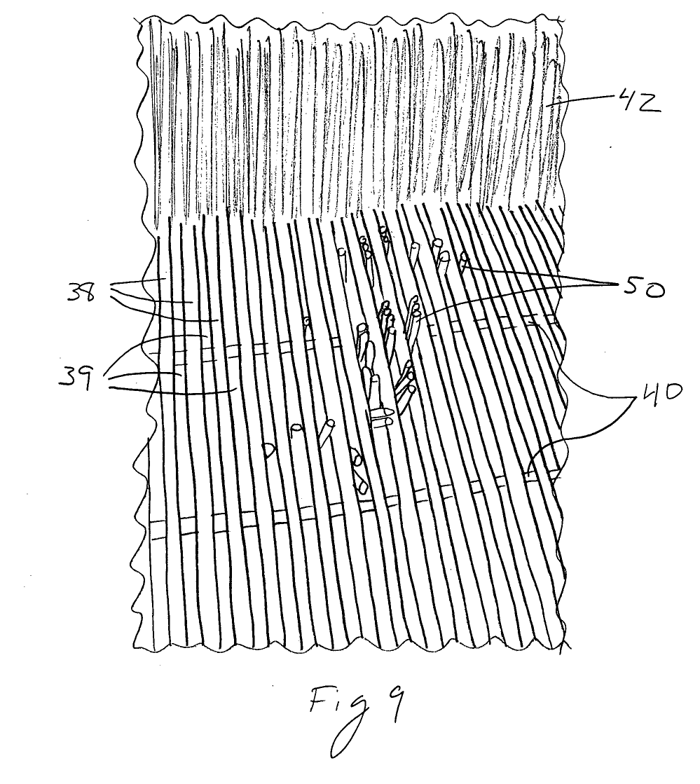

Screen 10 includes a first end plate 30 connected to the motor drive shaft 28, a second end plate 32 with a plurality of rollers 34 attached thereto, and a sidewall 36 formed by wedge wire 38 extending circumferentially around a center of the screen 10 and supported by support members 40 that longitudinally extend between the first and second end plates 30/32, as best shown in FIGS. 1 and 4-6. Wires 38 are separated from each other to form small openings 39 therebetween through which the water flows (as best seen in FIG. 9). Screen 10 is disposed around suction manifold 12, and is rotatably supported at one end by the motor drive shaft 28 and the other end by the rollers 34 (which engage the suction manifold cylindrical sidewall 20).

The external brush 14 includes bristles 42 supported by a support bracket 44, as best illustrated in FIGS. 2-5. Bristles 42 sweep across the outer surface of the screen sidewall 36 (wedge wire 38) as the screen 10 rotates relative to the suction manifold 12.

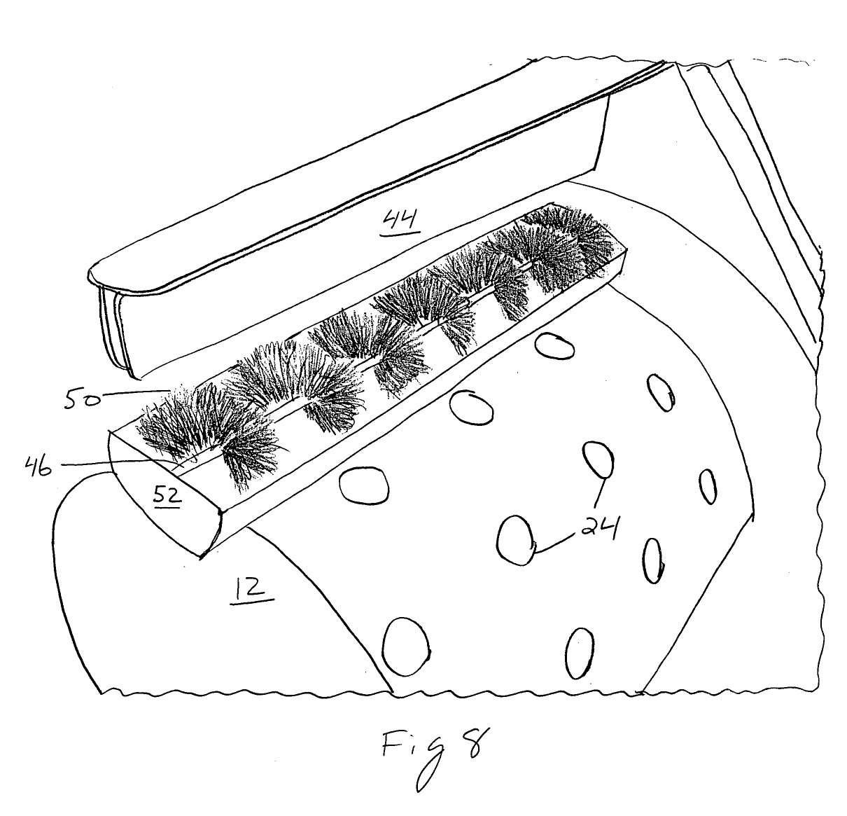

The internal brush 16 includes a shaft 46 rotatably mounted to the suction manifold 12 via brackets 48, and bristles 50 extending from the shaft 46 preferably, but not necessarily, in a spiral fashion, as best illustrated in FIGS. 2 and 7. Brackets 48 can be incorporated as end plates of a unitary trough or tray 52 for integrity, as best shown in FIGS. 3 and 8. The brush 16 is positioned to engage with the interior surface of screen sidewall 36 (wedge wire 38 and support members 40).

In operation, motor 26 rotates screen 10 relative to suction manifold 12. As screen 10 rotates, bristles 42 of fixed external brush 14 slide across the outer surface of sidewall 20 (i.e. outer surface of wedge wire 38) dislodging material such as debris and silt therefrom. Also, as screen 10 rotates, the support members 40 act as gear teeth by engaging with and rotating internal brush 16. As internal brush 16 rotates, its bristles 50 engage with support members 40 and inner and side surfaces of wedge wire 38, even poking through the wedge wire 38 as illustrated in FIG. 9. This engagement wipes and dislodges debris and silt from the support members 40 and the inner/side surfaces of wedge wire 38. By rotating with the passing support members 40 (in a passive manner), the internal brush 16 effectively cleans the interior of the screen 10 in a manner that the external fixed brush 14 can not. Also, by passively rotating internal brush 16 using the rotation of screen sidewall 36, a second motor and/or complicated gearing is avoided. Thus, the rotation of screen 10 operates both brushes (one fixed and one rotating) without the need for any additional motors or moving parts.

The preferred embodiment of the present invention includes a pair of screen assemblies 1 mounted to a single pump manifold. Hoist mechanisms can be used to lower and raise the intake screen assembly into a waterway for use. Components with dissimilar metals are electrically isolated to prevent electrolysis.

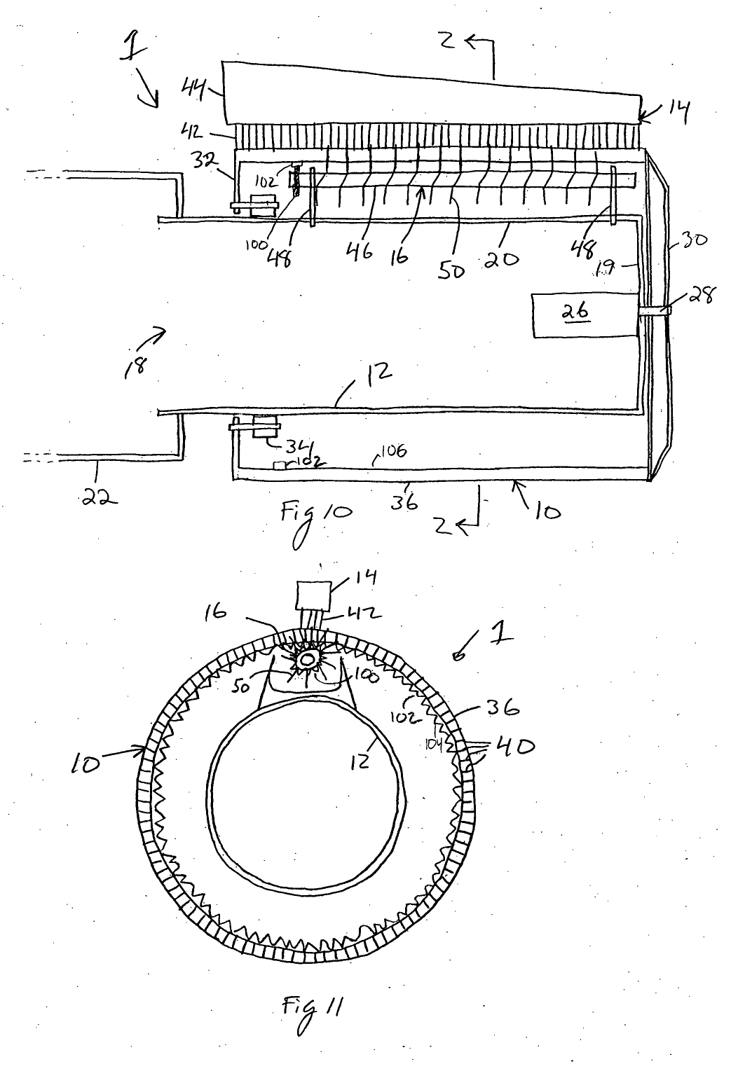

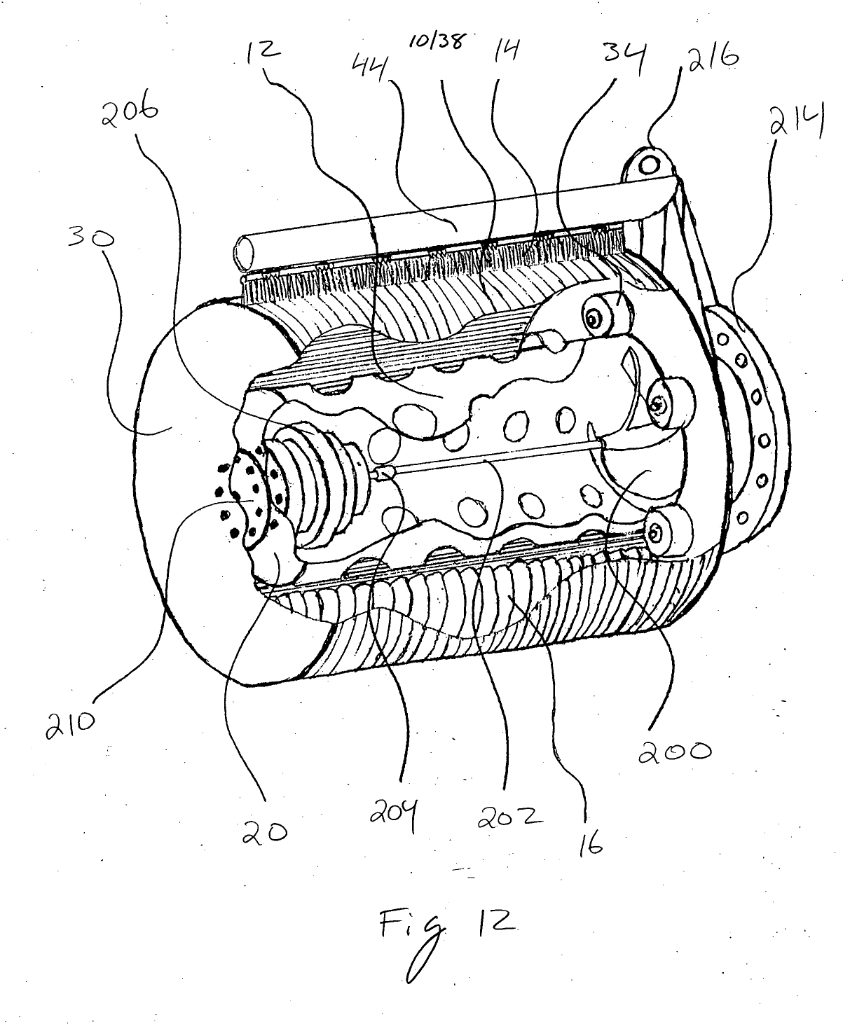

One of skill will realize that the present invention is not limited to the embodiment described above. Rather, alternate embodiments exist. FIGS. 10-11 illustrate one such alternate embodiment. The embodiment of FIGS. 10-11 highlights the fact that the present invention is not limited to configurations in which the brush 16 is rotated only by its bristles 50. Rather, here, the brush 16 has a gear 100 that is aligned with a complementary rack 102 that is positioned along the inner surface 104 of the screen 10, and whose teeth 104 are configured to interlock with the teeth of the gear 100 in a rack-and-pinion type arrangement. Accordingly, rotation of the screen 10 and rack 102 also induces rotation of the gear 100 and thus the brush 16. In this embodiment, the bristles 50 need not frictionally engage against the screen 10, as the brush 16 is turned by the rack 102 and gear 100. This reduces wear on the bristles 50 and extends the useful life of the brush 16.

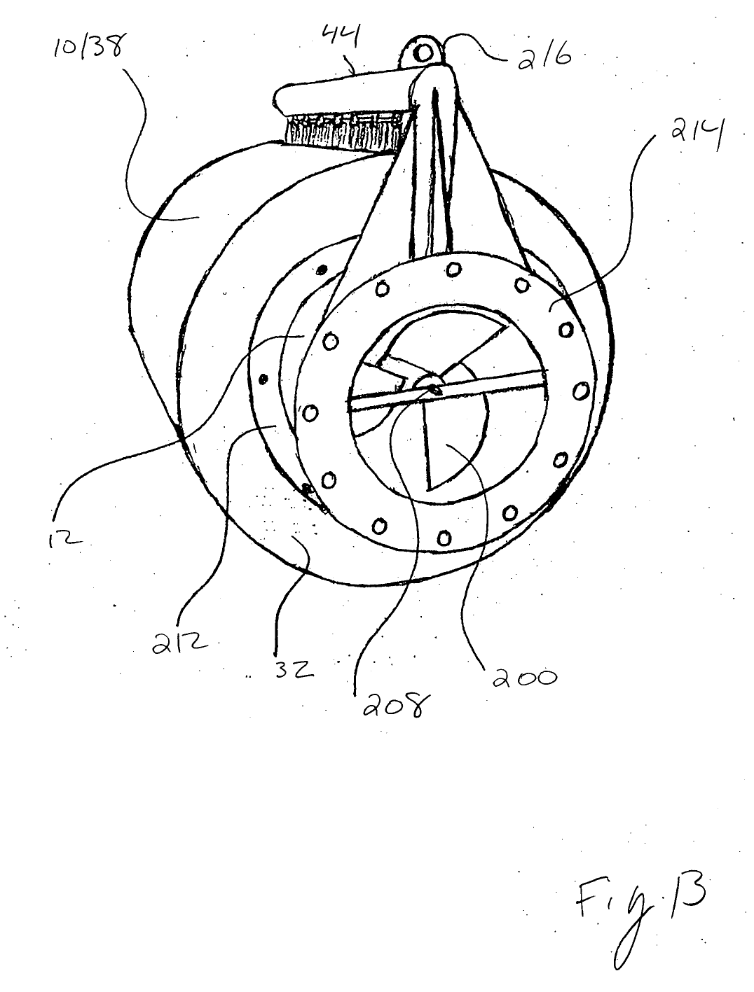

Another embodiment of the present invention is illustrated in FIGS. 12-13. Within such embodiment, motor 26 and shaft 28 of the previous embodiments are replaced with propeller 200, drive shaft 202, drive shaft coupling 204, gear box 206 (e.g. 1200:1 gear ratio), propeller bearing and support 208, gear box drive plate 210, seal 212 between the suction pipe (via flange 214) and rotating cylinder 10, and pick loop 216 (for hoisting the assembly into place). In this embodiment, water flowing through the suction manifold 12 drives propeller 200, which in turn rotates the drive shaft 202 and the coupling 204 to drive the gear box 206. The gear box 206 sufficiently down-gears the rotational movement of the drive shaft, so rotational force imparted on the screen cylinder end plate 30 via the gear box drive plate 210 is sufficient to rotate the screen 10 against all frictional forces (including those imparted by brushes 14 and 16). For example, using a 1200 to 1 gearbox, and a flow rate of 2000 gallons per minute, a rotation of 0.25 to 0.50 rpm of the cylinder 10 has been achieved.

The embodiment illustrated in FIGS. 12-13 provides inherent advantages over the previously described embodiments. For example, because this embodiment utilizes the pressure of flowing water to drive propeller 200, a motor dedicated to rotating the screen is not needed. Moreover, because this embodiment is a completely passive system, no underwater power is needed. As such, this embodiment reduces the cost and complexity, while enhancing reliability.

It is to be understood that the present invention is not limited to the embodiments described above and illustrated herein, but encompasses any and all variations falling within the scope of the appended claims. For example, the internal brush 16 is simply coupled to the screen 10 so that rotation of the screen 10 also moves the internal brush 16 against the screen 10. The brush 16 need not be moved specifically by its bristles 50, but instead can be moved by rotation of the screen 10 in any appropriate manner. The use of passively rotating internal brush 16 need not be used in conjunction with a suction manifold for applications where even water flow through the screen 10 is not needed. While internal and external brushes 14/16 are shown as mounted in an opposing fashion (on either side of the screen sidewall 36), such an opposing relationship is unnecessary. The screen sidewall 10 need not be formed of wedge wire 38 and support members 40, but can be formed of any mesh or other known screen materials (i.e. thin wires to thick wires that resemble rigid bars) that provide the desired filtration of water flowing therethrough and can engage and rotate the internal brush 16. The internal and external brushes 14/16 need not be brushes with protruding bristles 50/42, but can be any cleaning element capable of removing material from the intake screen 10, such as scrubbing pads or the like. In particular, the internal brush 16 can be a cleaning element having any configuration that allows it to engage against the intake screen 10 so as to induce rotation. The flow of water can be reversed from that shown, in which case the support members 40 are preferably on the outside of the screen as is the rotating brush 16, and the fixed brush 14 is mounted inside the screen. The spacing and sizes of holes 24 can be varied to create more even flow. And, brush 16 can be freely disposed in tray 52, without the ends thereof being rotatably attached to the tray ends. Lastly, the propeller 200 need not necessarily be coupled to the screen via the drive shaft 202, coupling 204 and gear box 206, but rather can be directly or indirectly coupled to the screen in any manner that imparts sufficient torque on the screen so that the screen rotates at the desired speed given the expectant flow rates of water.

Thus, the foregoing description of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Any element or combination from one embodiment can be incorporated in any other embodiment or combination.

What is claimed is:

1. A self-cleaning intake screen for filtering a flow of water, comprising:
a rotatable intake screen configured to filter material from a flow of water, the intake screen having openings for passing the flow of water;
a propeller coupled to the intake screen for rotating the intake screen as a flow of water passing the propeller drives the propeller; and
a first cleaning element operatively coupled to the intake screen so as to remove the material from the openings during rotation of the intake screen, wherein the first cleaning element is rotatably coupled to the intake screen so that rotation of the intake screen induces rotation of the first cleaning element against the intake screen, so as to remove the material from the openings when the intake screen is rotated;
wherein the openings are distributed across a cylindrical side portion of the intake screen, and wherein the first cleaning element extends longitudinally along an inner surface of the cylindrical side portion.

2. The self-cleaning intake screen of claim 1 further comprising a gear box coupled between the propeller and the intake screen.

3. The self-cleaning intake screen of claim 1 wherein the first cleaning element is a brush having bristles configured to protrude into the openings of the intake screen so as to remove the material from the openings.

4. The self-cleaning intake screen of claim 3 wherein the brush is rotatably coupled to the intake screen, and wherein rotation of the intake screen engages one or more sides of the openings against one or more of the bristles so as to rotate the brush, the rotation of the brush moving others of the bristles into others of the openings.

5. The self-cleaning intake screen of claim 1 further comprising a second cleaning element proximate to an outer surface of the cylindrical side portion, the second cleaning element configured to further remove the material from the openings and the outer surface when the intake screen is rotated.

6. The self-cleaning intake screen of claim 1 further comprising a gear coupled to the first cleaning element and a complementary rack coupled to the intake screen and the gear, wherein rotation of the intake screen and the pinion rotates the gear so as to induce rotation of the first cleaning element.

7. A self-cleaning intake screen for filtering a flow of water, comprising:
a manifold for passing a flow of water;
a cylindrically shaped screen defining a plurality of openings and rotatably mounted to the manifold;
a propeller disposed in the manifold and coupled to the intake screen for rotating the intake screen as a flow of water through the manifold drives the propeller; and
a first cleaning element rotatably mounted to the manifold and engaged with the screen such that rotation of the screen causes rotation of the cleaning element, wherein the first cleaning element is a brush with bristles, and wherein the bristles penetrate into the screen openings as the brush rotates;
wherein the screen includes:
a plurality of spaced apart wires with the openings defined between the wires; and
a plurality of support members extending along an interior surface of the screen;
wherein the bristles engage with the interior surface of the screen.

8. The self-cleaning intake screen of claim 7, further comprising a second cleaning element mounted to the manifold and adjacent an exterior surface of the screen, wherein the second cleaning element slides along the exterior surface as the screen rotates.

9. The self-cleaning intake screen of claim 7 further comprising a gear box coupled between the propeller and the screen.

10. The self-cleaning intake screen of claim 7, wherein the manifold includes a cylindrically shaped member about which the screen rotates, and wherein the first cleaning element is mounted between the cylindrically shaped member and the screen.

11. The self-cleaning intake screen of claim 7, wherein the first cleaning element includes a shaft.

12. The self-cleaning intake screen of claim 11, wherein the bristles extend from the shaft in a spiral manner.

13. The self-cleaning intake screen of claim 11, further comprising a tray mounted to the manifold, wherein the first cleaning element is rotatably disposed in the tray.

14. A self-cleaning intake screen for filtering a flow of water, comprising:
a cylindrically shaped manifold;
a cylindrically shaped screen disposed around the manifold in a rotatable manner relative to the manifold, the screen defining a plurality of openings;
a propeller disposed in the manifold and coupled to the intake screen for rotating the intake screen around the manifold as a flow of water through the manifold drives the propeller; and
a first cleaning element rotatably mounted to the manifold and disposed between the manifold and the screen, wherein the cleaning element is engaged with an interior surface of the screen such that rotation of the screen causes rotation of the cleaning element.

15. The self-cleaning intake screen of claim 14, wherein the cleaning element includes a shaft and a plurality of bristles extending from the shaft, and wherein the bristles extend into the screen openings as the screen rotates.

16. The self-cleaning intake screen of claim 15, further comprising a second cleaning element mounted to the manifold and adjacent an exterior surface of the screen, wherein the second cleaning element slides along an exterior surface of the screen as the screen rotates.

17. The self-cleaning intake screen of claim 15, further comprising a tray mounted to the manifold, wherein the cleaning element is rotatably disposed in the tray.

18. The self-cleaning intake screen of claim 14 further comprising a gear box coupled between the propeller and the screen.
